(19) United States
(12) Patent Application Publication
(10) Pub. No.: US 2016/0270130 A1
(43) Pub. Date: Sep. 15, 2016

(54) WIRELESS NETWORK SYSTEM AND METHOD FOR ESTABLISHING THE SAME

(71) Applicant: HTC Corporation, Taoyuan City (TW)

(72) Inventors: Yih-Jang CHEN, Taoyuan City (TW); Yen-Chuan LIN, Taoyuan City (TW)

(21) Appl. No.: 14/658,230

(22) Filed: Mar. 15, 2015

(51) Int. Cl. H04W 76/02; H04W 72/04

(52) U.S. Cl. CPC H04W 76/02; H04W 72/0453

(57) ABSTRACT

A wireless network system is provided. The wireless network system includes two terminal wireless network modules and at least one relay wireless network module. The relay wireless network module is connected wirelessly between the two terminal wireless network modules. The relay wireless network module includes dual physical layers, performs data transmission with a first wireless network module through a first physical layer of the dual physical layers within a first frequency band and performs data transmission with a second wireless network module through a second physical layer of the dual physical layers within a second frequency band at the same time. Each of the first and the second wireless network modules is one of the two terminal wireless network modules or another relay wireless network module, and the first and the second frequency bands are different.

### BACKGROUND

1. Field of Disclosure

The present disclosure relates to a wireless network technology. More particularly, the present disclosure relates to a wireless network system and a method for establishing the same.

2. Description of Related Art

The computer network urges the development of Internet such that more and more information is exchanged therethrough. The evolution of the bandwidth and the speed of the network technology makes the network becomes the most important media to spread the information. Among different types of networks, the wireless network is convenient since different electronic devices are able to perform data transmission without the need of physical connection of the wires. However, the coverage area of the wireless network provided to the electronic device is limited. Further, the data transmission through the wireless network may not be performed smoothly due to the blocking of the neighboring obstacles.

Accordingly, what is needed is a wireless network system and a method for establishing the same to address the issues mentioned above.

### SUMMARY

An aspect of the present disclosure is to provide a wireless network system. The wireless network system includes two terminal wireless network modules and at least one relay wireless network module. The relay wireless network module is connected wirelessly between the two terminal wireless network modules, wherein the relay wireless network module includes dual physical layers, performs data transmission with a first wireless network module through a first physical layer of the dual physical layers within a first frequency band and performs data transmission with a second wireless network module through a second physical layer of the dual physical layers within a second frequency band at the same time, wherein each of the first and the second wireless network modules is one of the two terminal wireless network modules or another relay wireless network module, and the first and the second frequency bands are different from each other.

According to an embodiment of the present disclosure, the relay wireless network module is a handheld electronic device.

According to another embodiment of the present disclosure, each of the two terminal wireless network modules is a wireless hotspot or a handheld electronic device.

According to yet another embodiment of the present disclosure, the relay wireless network module includes a first antenna and a second antenna, a transceiver unit and a processing unit. The transceiver unit is electrically connected to the first antenna and the second antenna. The processing unit is electrically connected to the transceiver unit through the first physical layer and the second physical layer, such that the processing unit performs data transmission with the first wireless network module through the first physical layer, the transceiver unit and the first antenna and performs data transmission with the second wireless network module through the second physical layer, the transceiver unit and the second antenna.

According to another embodiment of the present disclosure, the first frequency band and the second frequency band correspond to 2.4 gigahertz and 5 gigahertz respectively.

According to yet another embodiment of the present disclosure, the two terminal wireless network modules and the relay wireless network module perform data transmission through a WiFi network.

Another aspect of the present disclosure is to provide a wireless network system establishing method. The wireless network system establishing method includes the steps outlined below. At least one relay wireless network module is connected wirelessly between the two terminal wireless network modules, wherein the relay wireless network module comprises dual physical layers. Data transmission is performed with a first wireless network module through a first physical layer of the dual physical layers within a first frequency band by the relay wireless network module. Data transmission is performed with a second wireless network module through a second physical layer of the dual physical layers within a second frequency band by the relay wireless network module at the same time, wherein each of the first and the second wireless network modules is one of the two terminal wireless network modules or another relay wireless network module, and the first and the second frequency bands are different from each other.

According to an embodiment of the present disclosure, the relay wireless network module is a handheld electronic device.

According to another embodiment of the present disclosure, each of the two terminal wireless network modules is a wireless hotspot or a handheld electronic device.

According to yet another embodiment of the present disclosure, the relay wireless network module includes a first antenna and a second antenna, a transceiver unit and a processing unit. The transceiver unit is electrically connected to the first antenna and the second antenna. The processing unit is electrically connected to the transceiver unit through the first physical layer and the second physical layer. The wireless network system establishing method further includes the steps outlined below. Data transmission is performed with the first wireless network module through the first physical layer, the transceiver unit and the first antenna by the processing unit. Data transmission is performed with the second wireless network module through the second physical layer, the transceiver unit and the second antenna by the processing unit.

According to another embodiment of the present disclosure, the first frequency band and the second frequency band correspond to 2.4 gigahertz and 5 gigahertz respectively.

According to yet another embodiment of the present disclosure, the two terminal wireless network modules and the relay wireless network module perform data transmission through a WiFi network.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a wireless network system in an embodiment of the present disclosure;

FIG. 2 is a block diagram of the relay wireless network module in an embodiment of the present disclosure;

FIG. 3A is a timing diagram of the data transmission between the terminal wireless network modules using the relay wireless network modules each implemented by a configuration of a single physical layer in an embodiment of the present disclosure;

FIG. 3B is a timing diagram of the data transmission between the terminal wireless network modules using the relay wireless network modules each implemented by a configuration of the dual physical layers in an embodiment of the present disclosure; and

FIG. 4 is a flow chart of a wireless network system establishing method in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

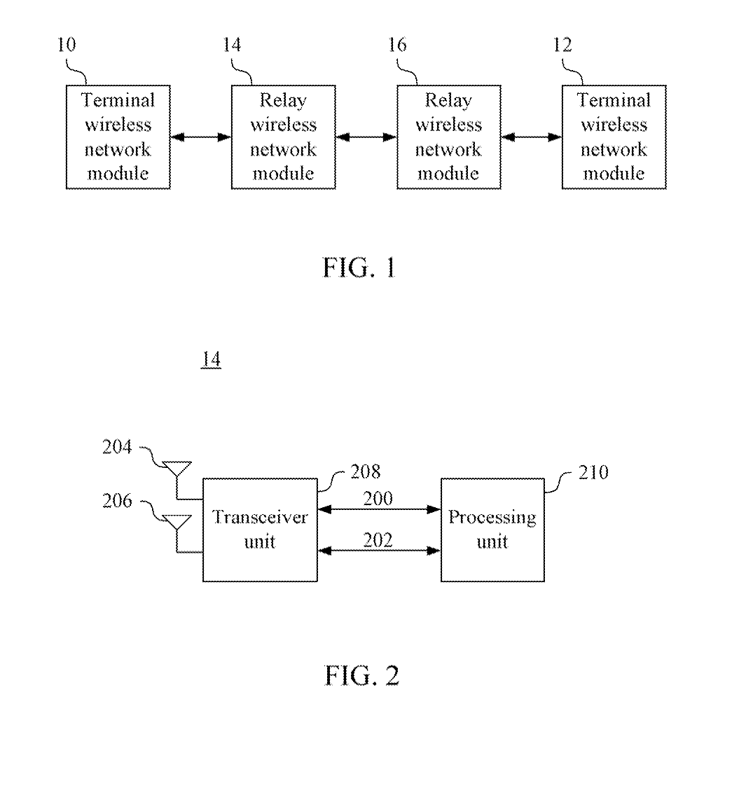

FIG. 1 is a block diagram of a wireless network system 1 in an embodiment of the present disclosure. The wireless network system 1 includes two terminal wireless network modules 10 and 12 and relay wireless network modules 14 and 16.

In different embodiments, each of the terminal wireless network modules 10 and 12 can be such as, but not limited to a wireless hotspot or a handheld electronic device. The relay wireless network modules 14 and 16 are connected wirelessly between the two terminal wireless network modules 10 and 12. The relay wireless network modules 14 and 16 receive and deliver the data supposed to be transmitted between the terminal wireless network modules 10 and 12.

The terminal wireless network modules 10 and 12 may not be able to perform data transmission directly due to the distance or the existence of obstacles. For example, when the distance between the terminal wireless network modules 10 and 12 is too far or there are obstacles such as high mountains or buildings blocking the transmission path between the terminal wireless network modules 10 and 12, the relay wireless network modules 14 and 16 can receive and deliver the data signal such that the terminal wireless network modules 10 and 12 can perform data transmission through the relay wireless network modules 14 and 16. In an embodiment, the terminal wireless network modules 10 and 12 and the relay wireless network modules 14 and 16 perform data transmission through such as, but not limited to a WiFi wireless network.

It is appreciated that the number of the relay wireless network modules 14 and 16 described above is merely an example. In other embodiments, the number of the relay wireless network modules 14 and 16 can be adjusted according to practical demands.

In an embodiment, each of the relay wireless network modules 14 and 16 can be such as, but not limited to a handheld electronic device. Moreover, in an embodiment, the relay wireless network modules 14 and 16 can include identical configurations. In the following paragraphs, the detailed description of the configurations of the relay wireless network modules 14 and 16 is made by using the relay wireless network module 14 as the example.

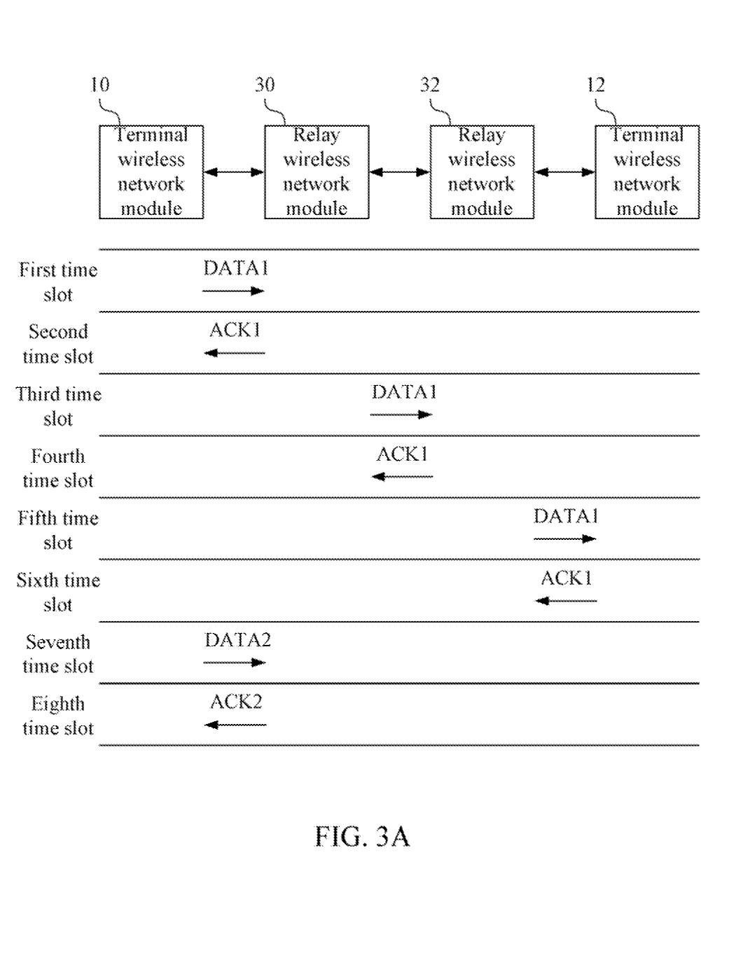

FIG. 2 is a block diagram of the relay wireless network module 14 in an embodiment of the present disclosure. The relay wireless network module 14 includes dual physical layers that include a first physical layer 200 and a second physical layer 202, a first antenna 204 and a second antenna 206, a transceiver unit 208 and a processing unit 210.

The transceiver unit 208 is electrically connected to the first antenna 204 and the second antenna 206. The processing unit 210 is electrically connected to the transceiver unit 208 through the first physical layer 200 and the second physical layer 202.

The processing unit 210 performs data transmission with the terminal wireless network module 10 through the first physical layer 200, the transceiver unit 208 and the first antenna 204, wherein such a data transmission is performed in the first frequency band.

Moreover, the processing unit 210 performs data transmission with the relay wireless network module 16 through the second physical layer 202, the transceiver unit 208 and the second antenna 206, wherein such a data transmission is performed in a second frequency band. The first frequency band and the second frequency band are different from each other. In an embodiment, the first frequency band can correspond to such as, but not limited to a frequency band within a range having a center at 2.4 gigahertz. The second frequency band can correspond to such as, but not limited to a frequency band that within a range having a center at 5 gigahertz.

Accordingly, the relay wireless network module 14 is able to perform data transmission simultaneously with different wireless network modules by using the dual physical layers in different frequency bands to increase the data transmission efficiency.

Similarly, the relay wireless network module 16 can perform data transmission simultaneously with the relay wireless network module 14 and the terminal wireless network module 12 by using the identical configuration. For example, the relay wireless network module 16 can perform data transmission with the relay wireless network module 14 according to one of the dual physical layers that is within a frequency band within a center at 5 gigahertz, and can perform data transmission with the terminal wireless network module 12 according to the other one of the dual physical layers that is within a frequency band having a center at 2.4 gigahertz.

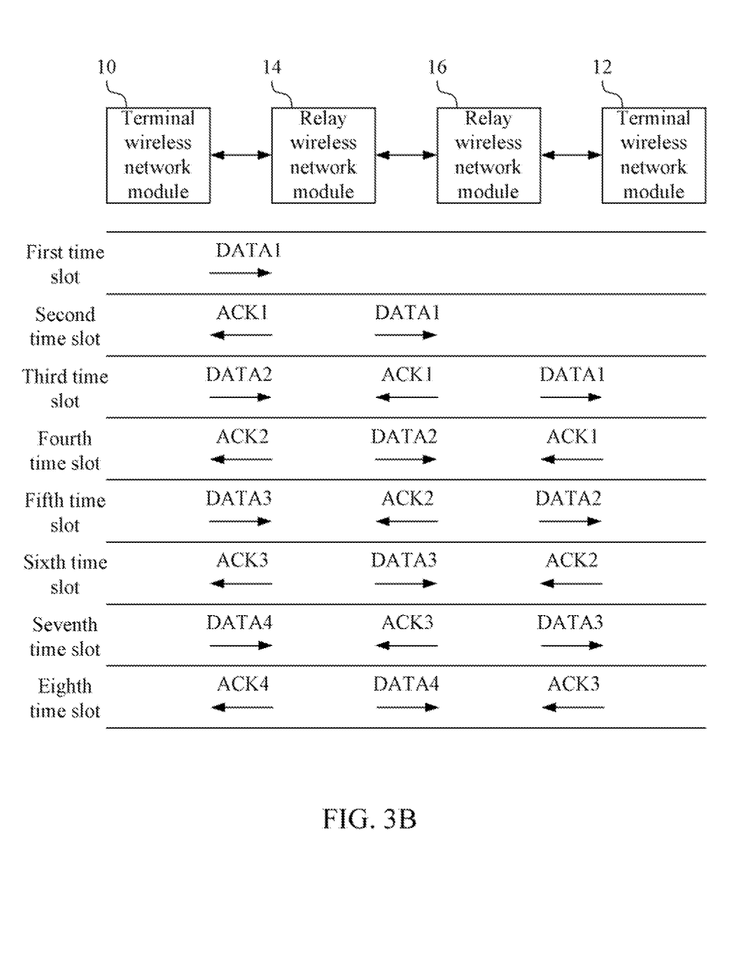

FIG. 3A is a timing diagram of the data transmission between the terminal wireless network modules 10 and 12 using the relay wireless network modules 30 and 32 each implemented by a configuration of a single physical layer in an embodiment of the present disclosure.

When the terminal wireless network module 10 wants to transmit data to the terminal wireless network module 12, as illustrated in FIG. 3A, since each of the relay wireless network modules 30 and 32 is implemented by the configuration of the single physical layer, only one piece of data in a single way can be transmitted within a single time slot. The relay wireless network module 30 receives a first data signal (illustrated as DATA1 in FIG. 3A) in a first time slot and transmits a first acknowledgement signal in a second time slot.

Further, the relay wireless network module 30 transmits the first data signal to the relay wireless network module 32 in a third timeslot and receives the first acknowledgement signal (illustrated as ACK1 in FIG. 3A) from the relay wireless network module 32 in a fourth time slot. The relay wireless network module 32 transmits the first data signal to the terminal wireless network module 12 in a fifth time slot and receives the first acknowledgement signal from the terminal wireless network module 12 in a sixth time slot. As a result, the first data signal transmitted by the terminal wireless network module 10 takes six time slots to be received by the terminal wireless network module 12. Moreover, the second data signal (illustrated as DATA2 in FIG. 3A) can only be transmitted until the seventh time slot begins.

FIG. 3B is a timing diagram of the data transmission between the terminal wireless network modules 10 and 12 using the relay wireless network modules 14 and 16 each implemented by a configuration of the dual physical layers in an embodiment of the present disclosure.

Similarly, when the terminal wireless network module 10 wants to transmit data to the terminal wireless network module 12, as illustrated in FIG. 3B, since each of the relay wireless network modules 30 and 32 is implemented by the configuration of the dual physical layers, two ways of data transmission can be performed within a single time slot. The relay wireless network module 14 receives the first data signal (illustrated as DATA1 in FIG. 3B) from the terminal wireless network module 10 in the first time slot. In the second time slot, the relay wireless network module 14 not only transmits the first acknowledgement signal (illustrated as ACK1 in FIG. 3B) to the terminal wireless network module 10, but also transmits the first data signal to the relay wireless network module 16.

Therefore, in the third time slot, the wireless network module 14 is able to receive the second data signal (illustrated as DATA2 in FIG. 3B) transmitted by the terminal wireless network module 10. In the same time slot, the relay wireless network module 16 not only transmits the first acknowledgement signal to the relay wireless network module 14, but also transmits the first data signal to the terminal wireless network module 12.

In the fourth time slot, the relay wireless network module 14 not only transmits the second acknowledgement signal (illustrated as ACK2 in FIG. 3B) to the terminal wireless network module 10, but also transmits the second data signal to the relay wireless network module 16. In the same time slot, the relay wireless network module 16 receives the second data signal and receives the first acknowledgement signal from the terminal wireless network module 12. The transmission of the first data signal is complete. Comparing to the embodiment illustrated in FIG. 3A, the method in FIG. 3B is faster by the time of two time slots.

In the fifth time slot, the wireless network module 14 is able to receive the third data signal (illustrated as DATA3 in FIG. 3B) transmitted by the terminal wireless network module 10. In the same time slot, the relay wireless network module 16 not only transmits the second acknowledgement signal to the relay wireless network module 14, but also transmits the second data signal to the terminal wireless network module 12.

In the sixth time slot, the relay wireless network module 14 not only transmits the third acknowledgement signal (illustrated as ACK3 in FIG. 3B) to the terminal wireless network module 10, but also transmits the third data signal to the relay wireless network module 16. In the same time slot, the relay wireless network module 16 receives the third data signal and receives the second acknowledgement signal from the terminal wireless network module 12.

In the seventh time slot, the wireless network module 14 is able to receive the fourth data signal (illustrated as DATA4 in FIG. 3B) transmitted by the terminal wireless network module 10. In the same time slot, the relay wireless network module 16 not only transmits the third acknowledgement signal to the relay wireless network module 14, but also transmits the third data signal to the terminal wireless network module 12.

In the eighth time slot, the relay wireless network module 14 not only transmits the fourth acknowledgement signal (illustrated as ACK4 in FIG. 3B) to the terminal wireless network module 10, but also transmits the fourth data signal to the relay wireless network module 16. In the same time slot, the relay wireless network module 16 receives the fourth data signal and receives the third acknowledgement signal from the terminal wireless network module 12.

As a result, in the eighth time slot, the transmission of only one piece of data is complete in the embodiment illustrated in FIG. 3A, and the second piece of data is just transmitted to the relay wireless network module 30. However, the transmission of three pieces of data is complete in the embodiment illustrated in FIG. 3B, and the fourth piece of data is already transmitted to the relay wireless network module 16. Comparing to the relay wireless network modules 30 and 32 each implemented by using a single physical layer, the data transmission efficiency is greatly increased in the relay wireless network modules 14 and 16 each implemented by using dual physical layers

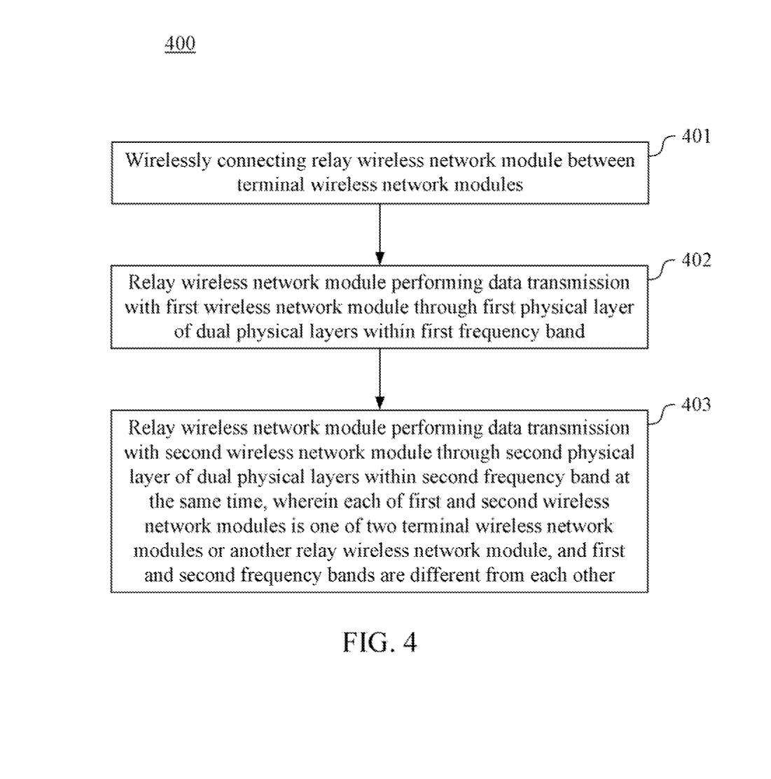

FIG. 4 is a flow chart of a wireless network system establishing method 400 in an embodiment of the present disclosure. The wireless network system establishing method 400 can be used in the wireless network system 1 illustrated in FIG. 1. The wireless network system establishing method 400 includes the steps outlined below.

In step 401, the relay wireless network modules 14 and 16 are wirelessly connected between the terminal wireless network modules 10 and 12.

In step 402, the relay wireless network modules 14 and 16 perform the data transmission with the first wireless network module through the first physical layer 200 of the dual physical layers within the first frequency band.

In step 403, the relay wireless network modules 14 and 16 perform the data transmission with the second wireless network module through the second physical layer 202 of the dual physical layers within the second frequency band at the same time, wherein each of the first and the second wireless network modules is one of the two terminal wireless network modules or another relay wireless network module, and the first and the second frequency bands are different from each other.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless network system, comprising:
two terminal wireless network modules; and
at least one relay wireless network module connected wirelessly between the two terminal wireless network modules, wherein the relay wireless network module comprises dual physical layers, performs data transmission with a first wireless network module through a first physical layer of the dual physical layers within a first frequency band and performs data transmission with a second wireless network module through a second physical layer of the dual physical layers within a second frequency band at the same time, wherein each of the first and the second wireless network modules is one of the two terminal wireless network modules or another relay wireless network module, and the first and the second frequency bands are different from each other.

2. The wireless network system of claim 1, wherein the relay wireless network module is a handheld electronic device.

3. The wireless network system of claim 1, wherein each of the two terminal wireless network modules is a wireless hotspot or a handheld electronic device.

4. The wireless network system of claim 1, wherein the relay wireless network module comprises:
a first antenna and a second antenna;
a transceiver unit electrically connected to the first antenna and the second antenna; and
a processing unit electrically connected to the transceiver unit through the first physical layer and the second physical layer, such that the processing unit performs data transmission with the first wireless network module through the first physical layer, the transceiver unit and the first antenna and performs data transmission with the second wireless network module through the second physical layer, the transceiver unit and the second antenna.

5. The wireless network system of claim 1, wherein the first frequency band and the second frequency band correspond to 2.4 gigahertz and 5 gigahertz respectively.

6. The wireless network system of claim 1, wherein the two terminal wireless network modules and the relay wireless network module perform data transmission through a WiFi network.

7. A wireless network system establishing method, comprising:
wirelessly connecting at least one relay wireless network module between the two terminal wireless network modules, wherein the relay wireless network module comprises dual physical layers;
the relay wireless network module performing data transmission with a first wireless network module through a first physical layer of the dual physical layers within a first frequency band; and
the relay wireless network module performing data transmission with a second wireless network module through a second physical layer of the dual physical layers within a second frequency band at the same time, wherein each of the first and the second wireless network modules is one of the two terminal wireless network modules or another relay wireless network module, and the first and the second frequency bands are different from each other.

8. The wireless network system establishing method of claim 7, wherein the relay wireless network module is a handheld electronic device.

9. The wireless network system establishing method of claim 7, wherein each of the two terminal wireless network modules is a wireless hotspot or a handheld electronic device.

10. The wireless network system establishing method of claim 7, wherein the relay wireless network module comprises a first antenna and a second antenna; a transceiver unit electrically connected to the first antenna and the second antenna; and a processing unit electrically connected to the transceiver unit through the first physical layer and the second physical layer; and the wireless network system establishing method further comprises:
the processing unit performing data transmission with the first wireless network module through the first physical layer, the transceiver unit and the first antenna; and
the processing unit performing data transmission with the second wireless network module through the second physical layer, the transceiver unit and the second antenna.

11. The wireless network system establishing method of claim 7, wherein the first frequency band and the second frequency band correspond to 2.4 gigahertz and 5 gigahertz respectively.

12. The wireless network system establishing method of claim 7, wherein the two terminal wireless network modules and the relay wireless network module perform data transmission through a WiFi network.
